(19) United States
(12) Patent Application Publication
(10) Pub. No.: US 2023/0100022 A1
(43) Pub. Date: Mar. 30, 2023

(54) BATTERY PACK ASSEMBLY

(71) Applicant: HYUNDAI MOBIS Co., Ltd., Seoul (KR)

(72) Inventor: Sang Woo KIM, Yongin-si (KR)

(73) Assignee: HYUNDAI MOBIS Co., Ltd., Seoul (KR)

(21) Appl. No.: 17/853,008

(22) Filed: Jun. 29, 2022

(30) Foreign Application Priority Data
Sep. 28, 2021 (KR) 10-2021-0128165
Nov. 23, 2021 (KR) 10-2021-0162726
Dec. 14, 2021 (KR) 10-2021-0178507

(51) Int. Cl. H01M 50/264; H01M 50/291; H01M 10/04; H01M 50/209; H01M 50/271

(52) U.S. Cl. CPC H01M 50/264; H01M 50/291; H01M 10/0481; H01M 50/209; H01M 50/271

(57) ABSTRACT

A battery cell unit may include: a plurality of prismatic battery cells; and a support bar disposed on either side of the plurality of battery cells, and configured to fix the plurality of battery cells. The support bar may include a base part constituting the body of the support bar, and extended in the direction that the battery cells are stacked; a first bent part formed at each of first and second end portions of the base part and bent in the direction that the battery cells are stacked; a second bent part formed at the tops of the base part and the first bent part, and bent in the direction that the battery cells are stacked; and a fixing panel formed at each of the first and second end portions of the base part, and bent in the opposite direction of the first bent part.

### CROSS-REFERENCE TO RELATED APPLICATIONS

This application claims the benefit under 35 USC § 119(a) of Korean Patent Application No. 10-2021-0128165 filed on Sep. 28, 2021 in the Korean Intellectual Property Office, Korean Patent Application No. 10-2021-0162726 filed on Nov. 23, 2021 in the Korean Intellectual Property Office, and Korean Patent Application No. 10-2021-0178507 filed on Dec. 14, 2021 in the Korean Intellectual Property Office, the entire disclosures of which is incorporated herein by reference for all purposes.

### BACKGROUND

### 1. Technical Field

The present disclosure relates to a battery pack assembly, and more particularly, to a battery pack assembly that is applied to a vehicle.

### 2. Related Art

In order to solve the environmental preservation problem and prepare for fossil fuel depletion all over the world, the development of eco-friendly vehicles such as HEV (Hybrid Electric Vehicle), PHEV (Plug-in Hybrid Electric Vehicle), FCEV (Fuel Cell Electric Vehicle), and EV (Electric Vehicle) has attracted attention.

Such eco-friendly vehicles are all driven by an electric motor, and necessarily include a high voltage battery pack for providing driving power to the electric motor.

The battery pack is configured to supply necessary power while repeatedly charged and discharged during driving.

Such a battery pack typically includes a plurality of battery modules.

Each of the battery modules includes a plurality of battery cells.

Such a battery pack includes the battery modules each including the plurality of battery cells and various components such as a wire harness and BMS (Battery Management System) in a case thereof.

The plurality of battery cells included in the battery module are fixed through end plates.

The end plate is disposed at the outermost position on either side of the plurality of battery cells, and maintains the surface pressure performance of the battery cells.

However, since the end plate is disposed at the outermost position on either side of the plurality of battery cells, and various components such as the wire harness and the BMS are mounted in the case of the battery pack, the space efficiency of the battery pack is degraded.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

Various embodiments are directed to a battery pack assembly which can raise the space efficiency of a battery back by omitting some of components housed in a case of the battery back.

The above-described objects and other objects of the present disclosure and the advantages and characteristics of the present disclosure and a method for achieving the objects, advantages and characteristics will be clearly understood with reference to embodiments to be described below in detail along with the accompanying drawings.

In one general aspect, a battery pack assembly includes: a plurality of battery cell units, each battery cell unit including a plurality of battery cells and a support bar configured to fix the plurality of battery cells; a case having a frame shape, and configured to house the battery cell units therein; and a plurality of surface pressure pads disposed in the case, each surface pressure pad being disposed between the case and an outermost battery cell on both ends of each of the plurality of battery cell units.

The battery cell units may be disposed along a longitudinal direction of the case.

The case may include: a frame member that defines a body of the case; a cover member disposed on the frame member and configured to cover the frame member; and a gasket disposed between the frame member and the cover member.

The frame member may include: a pair of first frames spaced apart from each other, and disposed adjacent to the outermost battery cells on both ends of each of the plurality of battery cell units, respectively; and a pair of second frames spaced apart from each other, and respectively disposed ends of the first frame.

The first frame may include: a cut area disposed at a position corresponding to one of the surface pressure pads; and an elastic part elastically deformed by the cut area and abutting the respective surface pressure pad.

Each elastic part may have a smaller area than each of the battery cells, and may have a larger area than each of the surface pressure pads.

Each of the first frames may have a cross-section corresponding to a rectangular frame shape, and the cut area and the elastic part of each of the first frames may be disposed at facing surfaces of the pair of first frames.

The gasket may be coupled to the frame member and the cover member through bolting.

The gasket may include: a support member formed in a rectangular frame shape, and having a bottom surface that comes into surface contact with a top surface of the frame member; a pair of pressurization members disposed at a position corresponding to the pair of first frames; and a pair of cover fixing members disposed at a position corresponding to the pair of second frames. The cover member may be seated on the top surface of the support member, and the pressurization member and the cover fixing member may be seated on the top surface of the cover member.

In another general aspect, a battery pack assembly may include: a battery cell unit; and a case configured to house the battery cell unit. The battery cell unit may include a plurality of battery cells arranged in parallel to a front-to-rear direction. The case may include a frame member defining an internal space in which the battery cell unit is housed. The frame member may include: a frame member body defining a body of the frame member, and having the internal space disposed therein; and a partition disposed in the internal space, spaced apart from an edge surface of the frame member body toward the battery cell, and configured to partition the internal space into a plurality of spaces. The partition may include a through-area through which the spaces partitioned by the partition communicate with each other.

The through-area may include: a first through-area extended upward; and a second through-area extended horizontally from the first through-area.

The battery cell unit may further include: a cell fixing member disposed on either side of the plurality of battery cells in a side-to-side direction, and configured to pressurize the plurality of battery cells in the side-to-side direction; and a buffer member disposed on each of a front surface and a rear surface of the battery cell unit, configured to pressurize the plurality of battery cells in the front-to-rear direction, and made of an elastic material.

In another general aspect, a battery pack assembly may include: a battery cell unit; and a case configured to house the battery cell unit. The battery cell unit may include: a plurality of battery cells disposed in parallel to a front-to-rear direction; a cell fixing member disposed on either side of the plurality of battery cells in a side-to-side direction, and configured to pressurize the plurality of battery cells in the side-to-side direction; and a buffer member disposed on each of a front surface and a rear surface of the battery cell unit, configured to pressurize the plurality of battery cells in the front-to-rear direction, and made of an elastic material. The case may include: a frame member defining an internal space in which the battery cell unit is housed; and a cover member coupled to the top of the frame member. The cell fixing member may be coupled to the frame member, and the buffer member may be spaced apart from the cell fixing member.

The frame member may include: a frame member body defining a body of the frame member, and having the internal space disposed therein; and a protrusion member protruding from the frame member toward the internal space. The cell fixing member may include: a body region brought into close contact with the plurality of member cells, and extended in the front-to-rear direction; and an assembly region having an indented portion protruding from an end portion of the body region in the front-to-rear direction to the outside in a side-to-side direction, and indented upward. The protrusion member may be inserted into and coupled to the indented portion of the assembly region.

A width of the protrusion member in the side-to-side direction may correspond to a width of the indented portion in the side-to-side direction.

In accordance with the present disclosure, it is possible to provide a simplified battery back assembly by removing an end plate which has been applied to the conventional battery back assembly.

Furthermore, the lower region of the surface pressure pad in the first frame may be connected to the first frame, and the elastic part may be elastically deformed by the cut area. Thus, although the battery cell swells, the elastic part may be elastically deformed to effectively prevent the degradation of the battery cell.

Furthermore, although the elastic part is elastically deformed by the pressurization of the surface pressure pad by the swelling of the battery cell, the airtightness performance of the battery pack assembly may be effectively maintained.

Other features and aspects will be apparent from the following detailed description, the drawings, and the claims.

### BRIEF DESCRIPTION OF THE DRAWINGS

FIG. 1 is a perspective view illustrating a battery cell unit in accordance with a first embodiment of the present disclosure.

FIG. 2 is a disassembled perspective view illustrating that the battery cell unit in accordance with the first embodiment of the present disclosure is disassembled.

FIG. 3 is a cross-sectional view taken along line A-A′ of FIG. 1.

FIG. 4 is a perspective view illustrating a battery pack assembly in accordance with the first embodiment of the present disclosure.

FIG. 5 is a disassembled perspective view illustrating that the battery pack assembly in accordance with the first embodiment of the present disclosure is disassembled.

FIG. 6 is a cross-sectional view taken along line B-B′ of FIG. 4.

FIG. 7 is a front view illustrating the battery pack assembly in accordance with the first embodiment of the present disclosure.

FIG. 8 is a disassembled perspective view illustrating that a case and the battery cell unit of the battery pack assembly in accordance with the first embodiment of the present disclosure are disassembled.

FIG. 9 is a disassembled perspective view illustrating a cover member and a gasket of the battery pack assembly in accordance with the first embodiment of the present disclosure.

FIG. 10 is a disassembled perspective view illustrating the structure of a battery pack assembly in accordance with a second embodiment of the present disclosure.

FIG. 11 is a perspective view illustrating the structure of a battery cell unit included in the battery pack assembly in accordance with the second embodiment of the present disclosure.

FIG. 12 is a plan view illustrating that a battery cell unit and a frame member, which are included in the battery pack assembly in accordance with the second embodiment of the present disclosure, are coupled to each other.

FIG. 13 is an expanded vertical cross-sectional view illustrating a cross-sectional structure of an end portion of the battery pack assembly in accordance with the second embodiment of the present disclosure in a front-to-rear direction.

FIG. 14 is a perspective view illustrating the internal structure of the frame member of the battery pack assembly in accordance with the second embodiment of the present disclosure.

FIG. 15 is a perspective view illustrating that the battery cell unit is mounted on the frame member of the battery pack assembly in accordance with the second embodiment of the present disclosure.

FIG. 16 is a perspective view illustrating the structure of a buffer member included in a battery pack assembly in accordance with a third embodiment of the present disclosure.

FIG. 17 is an expanded vertical cross-sectional view illustrating a cross-sectional structure of an end portion of the battery pack assembly in accordance with the third embodiment of the present disclosure in a front-to-rear direction.

FIG. 18 is a perspective view illustrating that a battery cell unit is mounted on a frame member of a battery pack assembly in accordance with another embodiment of the third embodiment of the present disclosure.

FIG. 19 is an expanded perspective view illustrating the battery pack assembly in accordance with the another embodiment of the third embodiment of the present disclosure, before the battery cell unit and the frame member are coupled.

FIG. 20 is a perspective view illustrating a coupling structure between the battery cell unit and the frame member when the battery cell unit of the battery pack assembly in accordance with the another embodiment of the third embodiment of the present disclosure has a first height in a top-to-bottom direction.

FIG. 21 is a perspective view illustrating a coupling structure between the battery cell unit and the frame member when the battery cell unit of the battery pack assembly in accordance with the another embodiment of the third embodiment of the present disclosure has a second height in the top-to-bottom direction.

### DETAILED DESCRIPTION

Embodiments of the present disclosure are provided to more completely describe the present disclosure to those skilled in the art. The following embodiments may be modified into various other forms, and the scope of the present disclosure is not limited to the following embodiments. Rather, the embodiments are provided to more reliably and completely describe the present disclosure, and to completely transfer the scope of the present disclosure to those skilled in the art. In the drawings, components are exaggerated for convenience and clarity of description, and like reference numerals represent the same elements. In this specification, the term “and/or” includes any one of corresponding listed items and one or more combinations thereof.

The terms used in this specification are used to describe a specific embodiment, and do not limit the present disclosure.

In this specification, the terms of a singular form may include plural forms unless referred to the contrary. Furthermore, in this specification, the terms “comprise” and/or “comprising” specify the presence of a shape, number, step, operation, member, element, and/or a group thereof, and do not exclude the presence or addition of one or more other shapes, numbers, steps, operations, members, elements, and groups thereof.

Hereafter, a battery cell unit in accordance with a first embodiment of the present disclosure will be described in detail with reference to the accompanying drawings.

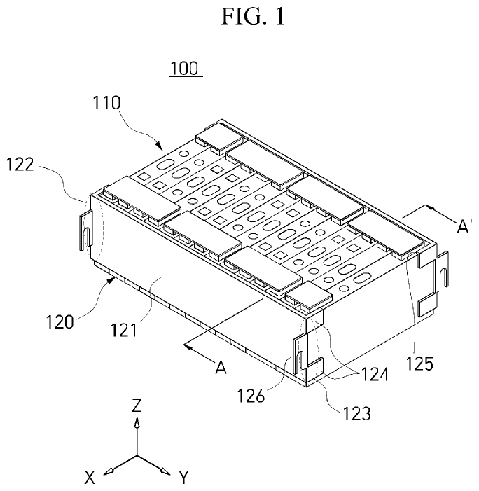

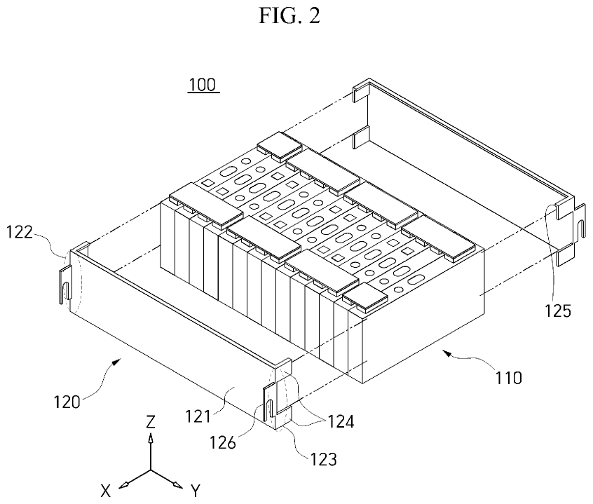

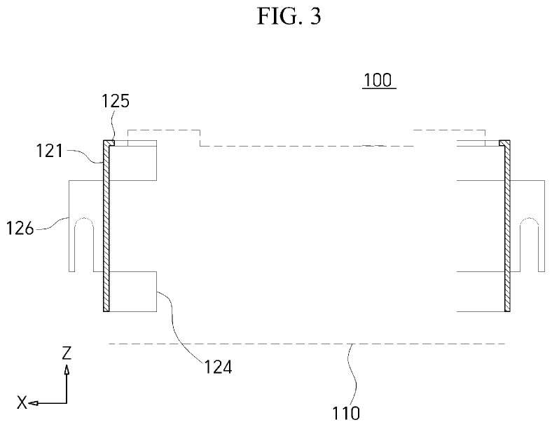

FIG. 1 is a perspective view illustrating the battery cell unit in accordance with the first embodiment of the present disclosure, FIG. 2 is a disassembled perspective view illustrating that the battery cell unit in accordance with the first embodiment of the present disclosure is disassembled, and FIG. 3 is a cross-sectional view taken along line A-A′ of FIG. 1.

Referring to FIGS. 1 to 3, a battery cell unit 100 in accordance with the first embodiment of the present disclosure includes a battery cell 110 and a support bar 120.

The battery cell 110 is provided as a plurality of battery cells which are stacked in the direction that the battery cells come into surface contact with one another.

The battery cell 110 is housed in a case 300 constituting a battery pack assembly.

The battery cell 110 in accordance with the embodiment of the present disclosure is configured as a prismatic battery cell 110 among a cylindrical battery cell, a pouch-type battery cell, and the prismatic battery cell that are typical battery cells.

The prismatic battery cell 110 has high durability, and thus has a longer lifetime than the cylindrical battery cell 110 and the pouch-type battery cell 110.

In particular, the prismatic battery cell 110 is formed in a rectangular shape suitable for being mounted in the case of the battery pack assembly, and thus has an advantage in terms of mass production. When the prismatic battery cell 110 is assembled, subsidiary materials may be easily mounted in the prismatic battery cell 110, which makes it possible to increase the efficiency of the internal space.

Furthermore, the prismatic battery cell is fabricated through a relatively simple process, which make it possible to lower the fabrication cost, and effectively shorten CT (Cycle Time).

The support bar 120 is provided as a pair of support bars which are disposed on both sides of the battery cells 110, respectively, which are stacked in the direction that the battery cells 110 come into surface contact with one another.

The support bar 120 is fixed to the case 300 constituting the battery pack assembly.

That is, the plurality of battery cells 110 are fixed to the case 300 of the battery pack assembly through the support bars 120.

The support bars 120 abut on the top surfaces, side surfaces, front surfaces, and rear surfaces of the plurality of battery cells 110.

That is, the support bars 120 may restrict the plurality of battery cells 110 from moving in X-axis, Y-axis, and Z-axis directions illustrated in FIGS. 1 to 3.

Such a support bar 120 includes a base part 121, a first bent part 124, a second bent part 125, and a fixing panel 126.

The base part 121 constitutes the body of the support bar 120, and is extended in the direction that the plurality of battery cells 110 are stacked.

The base part 121 abuts on the side surfaces of the plurality of stacked battery cells 110.

Therefore, the base part 121 prevents the plurality of battery cells 110 from moving in the X-axis direction illustrated in FIGS. 1 and 2.

The first bent part 124 is formed at each of a first end portion 122 and a second end portion 123 of the base part 121. The first end portion 122 is any one end portion of the base part 121, which is located in the direction that the battery cells 110 are stacked, and the second end portion 123 is located on the opposite side of the first end portion 122.

The first bent part 124 is bent from each of the first end portion 122 and the second end portion 123 of the base part 121 toward the battery cell 110.

Therefore, the first bent part 124 abuts on each of the front and rear surfaces of the battery cells 110 disposed at the outermost positions on both sides of the plurality of battery cells 110.

Thus, the first bent part 124 may effectively prevent the plurality of battery cells from moving the Y-axis direction illustrated in FIGS. 1 and 3.

In particular, the first bent part 124 is formed at the top and bottom of each of the first and second end portions 122 and 123 of the base part 121.

Therefore, the first bent part 124 may more effectively prevent the plurality of battery cells from moving the Y-axis direction illustrated in FIGS. 1 and 3.

The second bent part 125 is formed at the tops of the base part 121 and the first bent part 124.

That is, the second bent part 125 is connected along the top surfaces of the base part 121 and the first bent part 124.

In other words, the second bent part 125 is formed at the first bent part 124 formed at the top of the base part 121.

Furthermore, the second bent part 125 is bent from the tops of the base part 121 and the first bent part 124 toward the battery cell 110.

Therefore, the second bent part 125 abuts on the top surfaces of the plurality of battery cells 110.

Thus, the second bent part 125 may effectively prevent the plurality of battery cells from moving the Z-axis direction illustrated in FIGS. 1 and 3.

The fixing panel 126 is formed at each of the first and second end portions 122 and 123 of the base part 121. The fixing panel 126 is formed in a region that does not overlap the first bent parts 124 formed at the top and bottom of the base part 121, and bent in the opposite direction of the first bent part 124.

Such a fixing panel 126 fixes the battery cells 110, fixed by the base part 121, the first bent part 124, and the second bent part 125, to the case 300 constituting the battery pack assembly.

That is, the plurality of battery cells 110 are fixed to the case 300 of the battery pack assembly through the support bars 120.

Hereafter, the battery pack assembly in accordance with the first embodiment of the present disclosure will be described in detail with reference to the accompanying drawings.

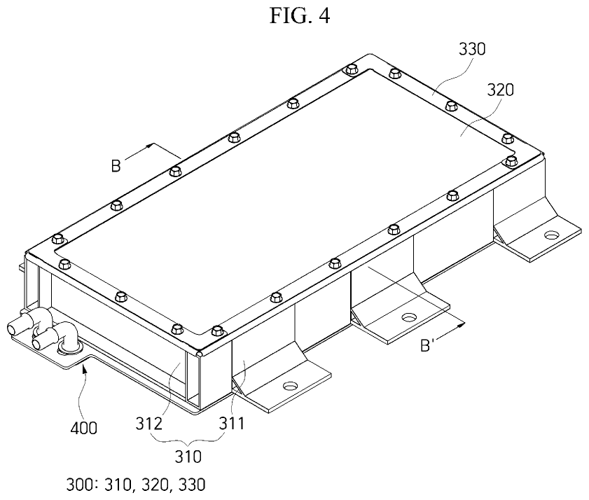

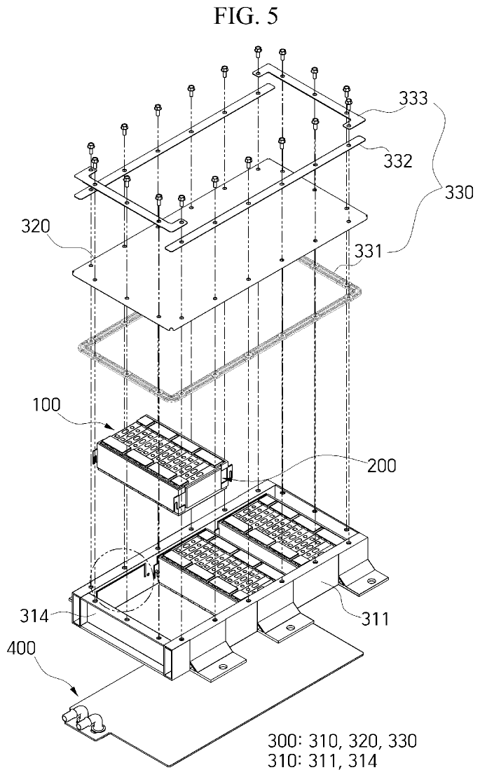

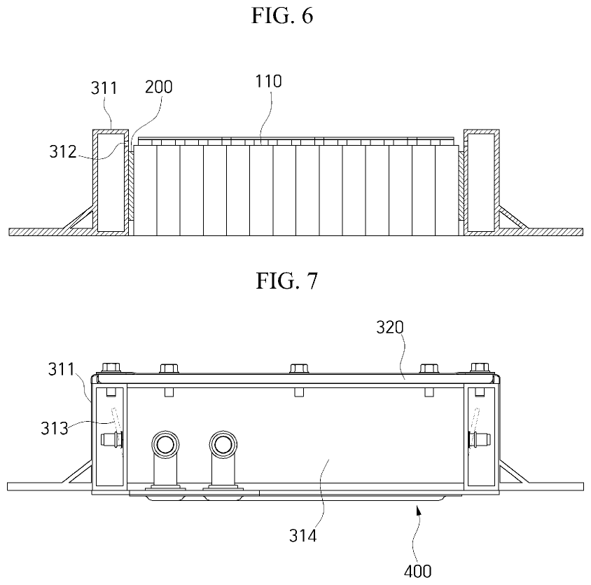

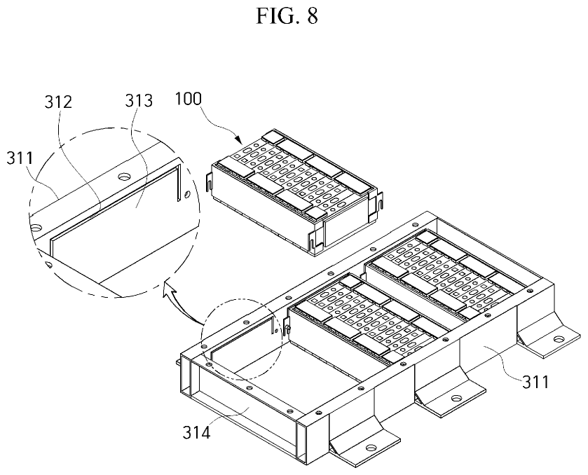

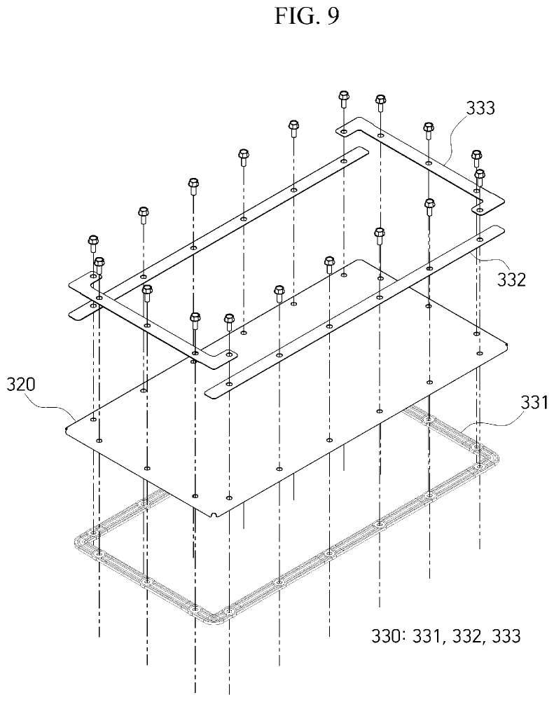

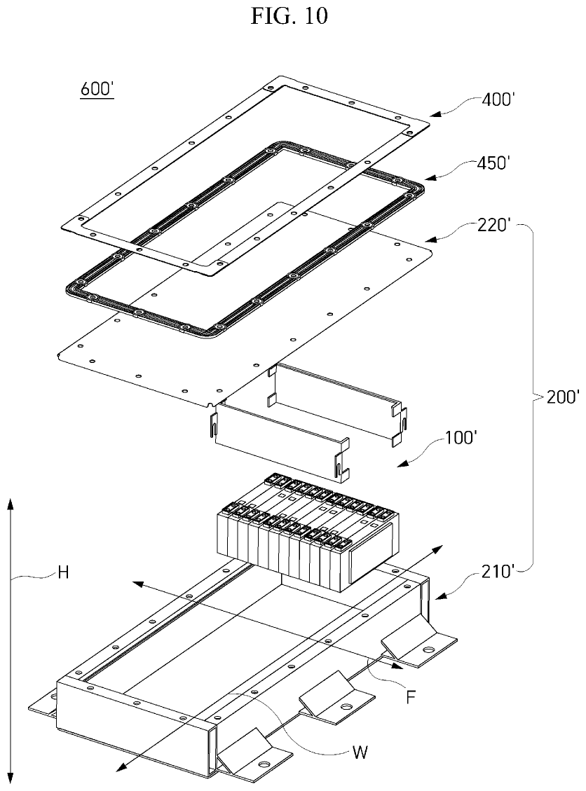

FIG. 4 is a perspective view illustrating the battery pack assembly in accordance with the first embodiment of the present disclosure, FIG. 5 is a disassembled perspective view illustrating that the battery pack assembly in accordance with the first embodiment of the present disclosure is disassembled, FIG. 6 is a cross-sectional view taken along line B-B′ of FIG. 4, FIG. 7 is a front view illustrating of the battery pack assembly in accordance with the first embodiment of the present disclosure, FIG. 8 is a disassembled perspective view illustrating that the case 300 and the battery cell unit 100 of the battery pack assembly in accordance with the first embodiment of the present disclosure are disassembled, and FIG. 9 is a disassembled perspective view illustrating a cover member 320 and a gasket 330 of the battery pack assembly in accordance with the first embodiment of the present disclosure.

The battery pack assembly in accordance with the present disclosure may be applied to CTP (Cell To Pack) technology capable of raising the space efficiency by removing a wire harness and the like which are included in an existing battery pack.

According to the CTP technology, an existing battery module may be omitted, and the battery cell 110 may be directly made into a battery pack. As described above, the CPT technology may raise the space efficiency to increase the number of the battery cells 110 mounted in the battery back, thereby increasing the mileage of an eco-friendly vehicle.

Referring to FIGS. 4 to 9, the battery pack assembly in accordance with the embodiment of the present disclosure includes a battery cell unit 100, a surface pressure pad 200, a case 300, and a cooling plate 400.

The battery cell unit 100 includes a plurality of battery cells 110 fixed by support bars 120, and is provided as a plurality of battery cell units.

The battery cell units 100 are stacked in a longitudinal direction orthogonal to the direction that the plurality of battery cells 110 are stacked in the case 300.

According to the size of the battery cell unit 100 and the number of the stacked battery cell units 100, the mileage of an echo-friendly vehicle may be adjusted.

The surface pressure pad 200 is configured to prevent the battery cell 110 from swelling, and is mounted on each of the battery cells 110 disposed at the outermost positions on both sides of the plurality of battery cells 110.

That is, the surface pressure pad 200 is disposed between the case 300 and the battery cell 110 seated in the case 300.

Furthermore, the surface pressure pad 200 is disposed between the pair of support bars 120 disposed on both side surfaces of the battery cell 110, respectively.

Therefore, the surface pressure pad 200 comes into surface contact with the battery cell 110.

Thus, the surface pressure pad 200 may pressurize the surface of the battery cell 110 and thus effectively prevent the battery cell 110 from excessively swelling.

The surface pressure pad 200 has a smaller area than the area of the battery cell 110.

The case 300 is configured as a rectangular frame in which a battery assembly and the surface pressure pad 200 are housed.

The case 300 includes a frame member 310, a cover member 320, and a gasket 330.

The frame member 310 forms the body of the case 300, and is configured as a rectangular frame when seen from the top.

Such a frame member 310 includes a first frame 311 and a second frame 314.

The first frame 311 is made of an extruded material, and provided as a pair of first frames that are spaced apart from each other.

The first frames 311 spaced apart from each other are disposed at the battery cells 110, respectively, which are disposed at the outermost positions on both sides of the plurality of battery cells 110.

That is, the surface pressure pads 200 are respectively disposed between the pair of first frames 311 and the plurality of battery cell units 100.

The first frame 311 has a cut area 312 and an elastic part 313.

The cut area 312 is formed at a position corresponding to the surface pressure pad 200, and formed in a region between the battery cell 110 and the surface pressure pad 200 in the first frame 311.

Specifically, the cut area 312 is formed by cutting the first frame 311 along one side region, an upper region, and the other side region of the surface pressure pad 200.

The elastic part 313 is formed by the cut area 312 in the first frame 311, and abuts on the surface pressure pad 200.

Specifically, as the cut area 312 is formed by cutting the first frame 311 along the one side region, the upper region, and the other side region of the surface pressure pad 200, a lower region of the surface pressure pad 200 in the first frame 311 is connected to the first frame 311.

Accordingly, the elastic part 313 is elastically deformed by the cut area 312. Thus, although the battery cell 110 swells, the elastic part 313 may be elastically deformed to effectively prevent the degradation of the battery cell 110.

In particular, the gasket 330 for improving the airtightness performance of the battery pack assembly is coupled to the tops of the first and second frames 311 and 314.

The elastic part 313 is spaced by a predetermined distance apart from the body of the first frame 311 by the cut area 312.

Therefore, the influence by the elastic deformation of the elastic part 313 on the gasket 330 is blocked by the cut area 312.

That is, although the elastic part 313 is elastically deformed by the swelling of the battery cell 110, the coupling between the gasket 330 and the first and second frames 311 and 314 is maintained.

Thus, although the elastic part 313 is elastically deformed by the pressurization of the surface pressure pad 200 when the battery cell swells, the cut area 312 may effectively maintain the airtightness performance of the battery pack assembly.

As illustrated in FIG. 7, the pair of first frames 311 of the case 300 may each have a cross-section corresponding to a rectangular frame shape.

The cut area 312 and the elastic part 313 are formed at facing surfaces of the pair of first frames 311 each having a cross-section corresponding to a rectangular frame shape.

Thus, the first frame 311 may form a space into which the elastic part 313 can be elastically deformed and pushed by the battery cell 110.

In particular, the elastic part 313 may adjust the surface pressure of the surface pressure pad 200 abutting on the elastic part 313, according to the length of the cut area 312 in the one side region and the other side region of the surface pressure pad 200.

For example, when the length of the cut area 312 in the one side region and the other side region of the surface pressure pad 200 is small, the surface pressure of the elastic part 313 to pressurize the surface pressure pad 200 is relatively high, and when the length of the cut area 312 in the one side region and the other side region of the surface pressure pad 200 is large, the surface pressure of the elastic part 313 to pressurize the surface pressure pad 200 is relatively low.

Thus, the elastic part 313 may easily adjust the surface pressure of the surface pressure pad 200, which is applied to the battery cell unit 100, through the cut area 312.

The support bar 120 is fixed to the first frame 311 by a bolt member passed through the fixing panel 126 of the support bar 120.

Thus, the plurality of battery cells 110 may be reliably fixed to the first frame 311 by the support bar 120.

The second frame 314 is made of an extruded material, and provided as a pair of second frames that are spaced apart from each other.

The second frames 314 spaced apart from each other are disposed on both side surfaces of the plurality of battery cell units 100, respectively.

The second frame 314 has a smaller length than the first frame 311.

The plurality of battery cells 110 may be stacked along the first frame 311 and fixed to the support bars 120, and the plurality of battery cell units 100 each including the plurality of battery cells 110 fixed by the support bars 120 may be stacked along the second frame 314.

The cover member 320 is disposed over the frame member 310 and covers the top of the frame member 310.

The cover member 320 is coupled to the top of the frame member 310 through bolting.

Thus, the cover member 320 may prevent foreign matters from flowing into the frame member 310.

The gasket 330 is disposed between the frame member 310 and the cover member 320, and a bolt passed through the cover member 320 is coupled to the frame member 310.

That is, the gasket 330 may improve the airtightness performance of the battery pack assembly.

The gasket 330 includes a support member 331, a pressurization member 332, and a cover fixing member 333.

The support member 331 is configured as a rectangular frame corresponding to the frame member 310, and the bottom surface of the support member 331 comes into surface contact with the top surface of the frame member 310.

The cover member 320 is seated on the top surface of the support member 331.

That is, the cover member 320 is indirectly seated on the top surface of the frame member 310.

The pressurization member 332 is provided as a pair of pressurization members, and extended in a direction corresponding to the first frame 311 of the frame member 310 and disposed at a position corresponding to the first frame 311.

The pressurization member 332 is seated on the top surface of the cover member 320 seated on the support member 331.

The cover fixing member 333 is provided as a pair of cover fixing members, and extended in a direction corresponding to the second frame 314 of the frame member 310 and disposed at a position corresponding to the second frame 314.

Both end portions of one cover fixing member 333 and both end portions of the other cover fixing member 333, between the pair of cover fixing members 333, are bent in directions facing each other.

Thus, both end portions of the pair of cover fixing members cover both end portions of the pair of pressurization members 332, respectively.

As the cover member 320 is fixed by the pressurization members 332 and the cover fixing members 333 while the frame member 310 and the support member 331 are brought into surface contact with each other, the gasket 330 having the above-described stacked structure may improve the airtightness performance of the battery pack assembly.

The cooling plate 400 is provided as a plurality of cooling plates corresponding to the plurality of battery cell units 100, and each of the cooling plates has an independent compartment structure.

The plurality of cooling plates 400 cool the respective battery cell units 100.

For this operation, cooling water for cooling the battery cell unit 100 is introduced into the cooling plate 400.

When the cooling water flows through the cooling plate 400 and a water-cooled battery module is charged or discharged, the cooling plate 400 absorbs the heat generated by the battery cell 110.

The cooling plates 400 are disposed under the respective battery cell units 100, and formed outside the battery cell unit 100.

For this structure, the cooling plates 400 are coupled to the bottom surface of the case through a welding method.

Such a welding method may be performed by MIG (Metal electrode Inert Gas) welding, FSW (Friction Stir Welding), or a combination thereof.

Therefore, the cooling plates 400 may be reliably coupled to the case, and improve the airtightness performance of the battery pack assembly.

Hereafter, a battery pack assembly in accordance with a second embodiment of the present disclosure will be described in detail with reference to the accompanying drawings.

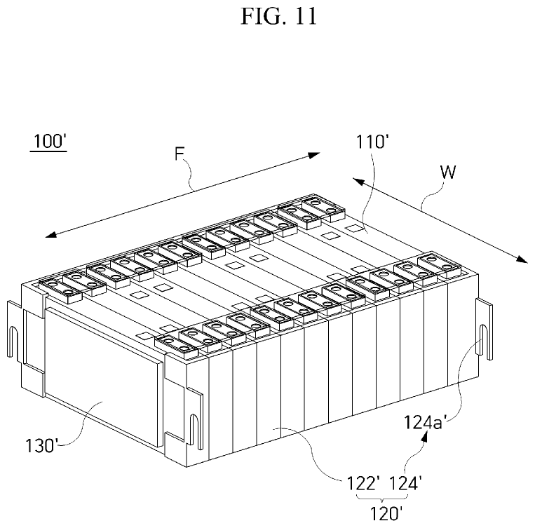

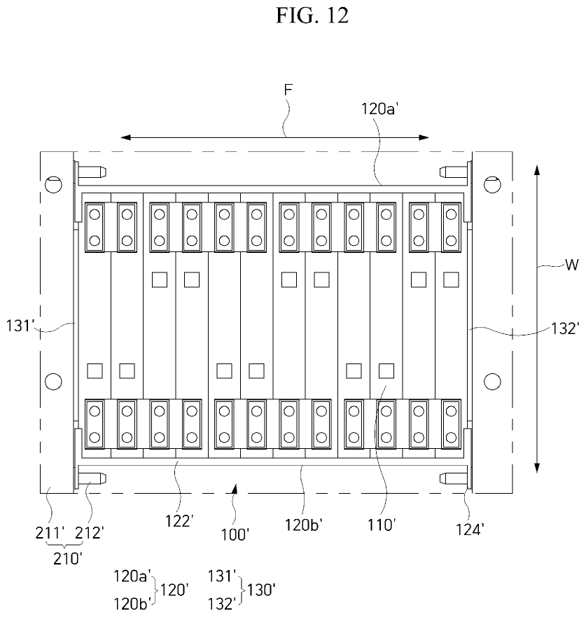

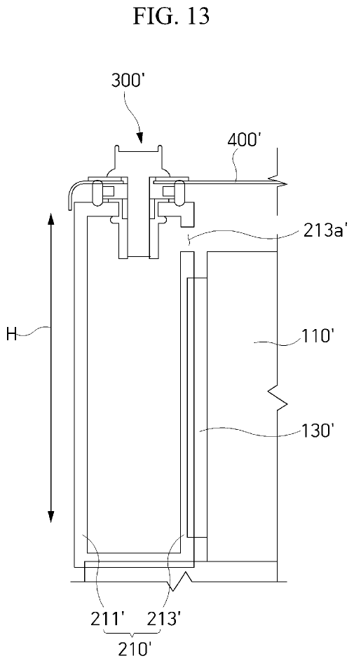

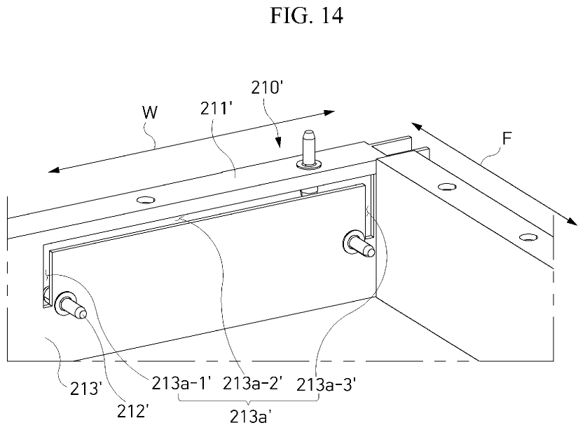

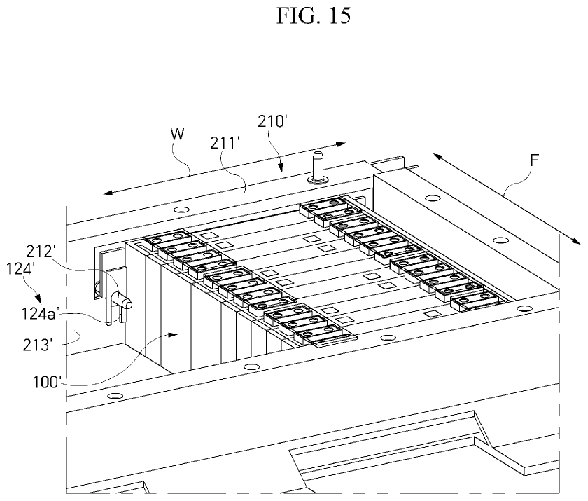

FIG. 10 is a disassembled perspective view illustrating the structure of the battery pack assembly in accordance with the second embodiment of the present disclosure, FIG. 11 is a perspective view illustrating the structure of a battery cell unit included in the battery pack assembly in accordance with the second embodiment of the present disclosure, FIG. 12 is a plan view illustrating that a battery cell unit and a frame member, which are included in the battery pack assembly in accordance with the second embodiment of the present disclosure, are coupled to each other, FIG. 13 is an expanded vertical cross-sectional view illustrating a cross-sectional structure of an end portion of the battery pack assembly in accordance with the second embodiment of the present disclosure in a front-to-rear direction, FIG. 14 is a perspective view illustrating the internal structure of the frame member of the battery pack assembly in accordance with the second embodiment of the present disclosure, and FIG. 15 is a perspective view illustrating that the battery cell unit is mounted on the frame member of the battery pack assembly in accordance with the second embodiment of the present disclosure.

A battery pack assembly 600′ in accordance with the second embodiment of the present disclosure may include a battery cell unit 100′ and a case 200′ for housing the battery cell unit 100′.

The battery cell unit 100′ may include a plurality of battery cells 110′ disposed in parallel to a front-to-rear direction F of the battery pack assembly 600′, a cell fixing member 120′ provided on either side of the plurality of battery cells 110′ in a side-to-side direction W of the battery pack assembly 600′ and configured to pressurize the plurality of battery cells 110′ in the side-to-side direction W, and a buffer member 130′ provided on each of front and rear surfaces of the battery cell unit 100′ and configured to pressurize the plurality of battery cells 110′ in the front-to-rear direction F.

In accordance with the present disclosure, the buffer member 130′ may be made of an elastic material. For example, the buffer member 130′ may be made of rubber.

The buffer member 130′ may be configured to absorb a change in volume of the battery cell 100′ when the battery cell 100′ swells.

In accordance with the present disclosure, the cell fixing member 120′ and the buffer member 130′ may be configured to pressurize the plurality of battery cells 100′ included in the battery cell unit 100′.

In particular, the buffer member 130′ may be configured to pressurize the plurality of battery cells 110′ in the front-to-rear direction F, and prevent the battery cell 110′ from swelling.

Although not illustrated in the drawings, a pad member made of rubber may be provided between the respective battery cells 110′, and the buffer member 130′ may be made of the same material as the above-described pad member. However, the buffer member 130′ may be made of a different material from the above-described pad member.

The above-described buffer member 130′ may be a component for replacing an end plate included in a battery module of a battery pack assembly according to the related art.

Therefore, since the battery pack assembly in accordance with the present disclosure includes no end plate, a process of fabricating a battery module is not needed as a previous step for fabricating the battery pack assembly.

Therefore, in accordance with the present disclosure, the battery pack assembly capable of providing the plurality of batteries with pressure for preventing swelling may be provided with an end plate removed from the battery pack assembly.

In this specification, the concept referred to as the battery cell unit 100′ has been introduced for convenience of description. However, it is to be noted that the battery cell unit 100′ mentioned in this specification is a different concept from the battery module according to the related art.

As described above, the buffer member 130′ may be a component for replacing the end plate included in the battery pack assembly in the related art according to the related art.

According to the related art, the end plate may be coupled to a support bar installed on either side of the battery module in the side-to-side direction of the battery.

Therefore, the end plate coupled to the support bar pressurizes the battery in the front-to-rear direction.

On the contrary, in accordance with the present disclosure, the buffer member 130′ may be spaced by a predetermined distance apart from the cell fixing member 120′ as illustrated in FIG. 12.

Therefore, in accordance with the present disclosure, the buffer member 130′ may neither be coupled to the cell fixing member 120′, nor come into contact with the cell fixing member 120′.

Referring to FIGS. 10 to 15, the case 200′ may include a frame member 210′ having an internal space in which the battery cell unit 100′ is housed and a cover member 220′ coupled to the top of the frame member 210′.

For example, the frame member 210′ may have approximately a U-shaped vertical cross-section, and the cover member 220′ may have approximately a plate shape.

In accordance with the present disclosure, the cell fixing member 120′ may be coupled to the frame member 210′. As described above, the buffer member 130′ and the cell fixing member 120′ are not coupled to each other. Thus, in order to fix the plurality of battery cells 110′, the cell fixing member 120′ needs to be fixed to another component.

Therefore, in accordance with the present disclosure, the cell fixing member 120′ may be directly coupled to the frame member 210′ in order to fix the plurality of battery cells 110′.

That is, in accordance with the present disclosure, the cell fixing member 120′ may be directly coupled to the frame member 210′ without a separate end plate unlike in the related art, such that the plurality of battery cells 110′ are fixed to the case 200′.

The frame member 210′ may include a frame member body 211′ and a protrusion member 212′. The frame member body 211′ forms the body of the frame member 210′ and has the internal space formed therein, and the protrusion member 212′ protrudes from the inner surface of the frame member toward the internal space.

More specifically, the frame member 210′ may further include a partition 213′ that is disposed in the internal space of the frame member body 211′ and spaced apart from the edge surface of the frame member body 211′ toward the battery cell 110′ and partitions the internal space in a plurality of spaces.

At this time, the protrusion member 212′ may protrude and extend from the partition 213′ toward the battery cell 110′.

For example, the partition 213′ is provided as a plurality of partitions 213′ which are provided in a front region and a rear region of the frame member 210′ in the front-to-rear direction F, respectively, and two protrusion members 212′ may be provided on each of the partitions 213′ provided in the front and rear regions of the frame member 210′.

The protrusion member 212′ may be a component for fixing the cell fixing member 120′ to the frame member 210′. More specifically, the cell fixing member 120′ may include a body region 122′ brought into close contact with the plurality of battery cells 110′ and extended in the front-to-rear direction F and an assembly region 124′ protruding from an end portion of the body region 122′ in the front-to-rear direction F to the outside in the side-to-side direction W.

In this case, as illustrated in FIG. 15, the assembly region 124′ may have an indented portion 124a′ formed at the bottom thereof and indented upward, and the protrusion member 212′ may be inserted into and coupled to the indented portion 124a′ of the assembly region 124′.

Therefore, in accordance with the present disclosure, the cell fixing member 120′ and the protrusion member 212′ may be coupled by the interference between the protrusion member 212′ and the assembly region 124′. Thus, the battery cell unit 100′ may be fixed to the frame member 210′. The width of the protrusion member 212′ in the side-to-side direction W may correspond to the width of the indented portion 124a′ in the side-to-side direction W such that the cell fixing member 120′ and the protrusion member 212′ are reliably coupled to each other in order to prevent the battery cell unit 100′ from moving in the horizontal direction.

More specifically, the cell fixing member 120′ may include a right cell fixing member 120a′ brought into close contact with the right side of the plurality of battery cells 110′ in the side-to-side direction W and a left cell fixing member 120b′ brought into close contact with the left side of the plurality of battery cells 110′ in the side-to-side direction W.

In this case, the assembly region 124′ included in the right cell fixing member 120a′ may be disposed at each of both ends of the body region 122′ of the right cell fixing member 120a′ in the front-to-rear direction F, and the assembly region 124′ included in the left cell fixing member 120b′ may be disposed at each of both ends of the body region 122′ of the left cell fixing member 120b′ in the front-to-rear direction F.

That is, the right cell fixing member 120a′ and the left cell fixing member 120b′ may each include two assembly regions 124′.

As illustrated in FIG. 14, in accordance with the present disclosure, the partition 213′ included in the frame member 210′ may include a through-area 213a′ through which the internal spaces partitioned by the partition 213′ communicate with each other.

The partition 213′ may be brought into close contact with the buffer member 130′ so as to pressurize the buffer member 130′.

Therefore, the frame member 210′ may pressurize the battery cell 110′ through the partition 213′. Therefore, in accordance with the present disclosure, the frame member 210′ may pressurize the battery cell 110′ without a separate component such as an end plate, which makes it possible to minimize the swelling of the battery cell 110′.

As described above, the buffer member 130′ is a component for absorbing a change in volume of the battery cell 110′ which has swelled.

However, when the change in volume of the battery cell 110′ which has swelled exceeds the limit to a volume change which can be absorbed by the buffer member 130′, an increase in pressure caused by the increase in volume of the battery cell 110′ is also transferred to the partition 213′.

The increase in pressure may deform the partition to deform the case including the frame member. As a result, the battery pack assembly is deformed.

Thus, the sealing performance which is necessarily required for the battery pack assembly may be degraded.

The through-area 213a′ may be a component for inducing the deformation of the partition 213′ with respect to external pressure, in order to minimize the change in shape of the battery pack assembly.

That is, in accordance with the present disclosure, when the battery cell 110′ excessively swells, the partition 213′ may be deformed by the through-area 213a′.

Therefore, as the partition 213′ is deformed before the frame member body 211′ constituting the body of the frame member 210′ is deformed, the exterior shape of the case 200′ including the frame member 210′ may be prevented from being changed. Thus, although the battery cell 110′ excessively swells, the sealing performance of the battery pack assembly may be still maintained.

However, in accordance with another embodiment of the present disclosure, the above-described through-area 213a′ may not be formed in the partition 213′.

That is, as long as the sealing performance of the battery pack assembly can be secured even though the battery cell 110′ swells, the through-area 213a′ may not be a necessary component for the battery pack assembly in accordance with the present disclosure.

More specifically, as illustrated in FIG. 14, the through-area 213a′ may include a first through-area 213a-1′ extended upward, a second through-area 213a-2′ extended horizontally from an upper end of the first through-area 213a-1′, and a third through-area 213a-3′ extended downward from the second through-area 213a-2′.

That is, the through-area 213a′ may have approximately a U-shape inverted in a top-to-bottom direction.

Unlike the structure illustrated in FIG. 14, however, the through-area 213a′ may have a straight line shape extended in the side-to-side direction W.

In accordance with the present disclosure, the frame member 210′ may be manufactured through various methods.

For example, the frame member 210′ may be manufactured through an extrusion method, a casting method or a pressing method, and the component connected to the bottom surface of the frame member 210′, for example, the outer surface of the frame member 210′ or the partition 213′ may be welded to the bottom surface of the frame member 210′ through MIG welding, brazing welding or FSW welding.

However, the manufacturing method of the frame member 210′ is not limited to the above-described methods, but various methods publicly-known in the related art may be used.

As illustrated in FIG. 12, the buffer member 130′ may include a front buffer member 131′ provided on the front surface of the battery cell unit 100′ and a rear buffer member 132′ provided on the rear surface of the battery cell unit 100′.

In this case, the front buffer member 131′ may be disposed so as to face the partition 213′ disposed at the front region of the frame member 210′, and the rear buffer member 132′ may be disposed so as to face the partition 213′ disposed at the rear region of the frame member 210′.

More desirably, the partition 213′ disposed at the front region of the frame member 210′ may pressurize the front buffer member 131′, and the partition 213′ disposed at the rear region of the frame member 210′ may pressurize the rear buffer member 132′.

As described above, the buffer member 130′ is spaced apart from the cell fixing member 120′. Thus, the buffer member 130′ is not coupled to the cell fixing member 120′.

Therefore, the buffer member 130′ needs to be fixed to the battery cell 110′ by another component.

In accordance with the present disclosure, since the buffer member 130′ is pressurized by the partition 213′, the buffer member 130′ may be fixed to the battery cell 110′ by the pressure, even though the buffer member 130′ is not directly coupled to other components including the cell fixing member 120′.

Referring to FIGS. 14 and 15, the width of the front buffer member 131′ or the rear buffer member 132′ in the side-to-side direction W may be smaller than the width of the through-area 213a′ in the side-to-side direction W, and the front buffer member 131′ or the rear buffer member 132′ may be located within the width of the through-area 213a′ in the side-to-side direction W.

Thus, although the battery cell 110′ excessively swells, the shape of the case 200′ may be locally changed only within the through-area 213a′.

As illustrated in FIGS. 10 and 13, the battery pack assembly 600′ in accordance with the present disclosure may further include a sealing member 300′ that penetrates the cover member 220′ in a top-to-bottom direction H, and seals the internal space from the outside.

Furthermore, the battery pack assembly 600′ may further include a bracket member 400′ spaced apart upward from the cover member 220′ and having a looped curve shape extended along the edge of the cover member 220′, and a rubber member 450′ provided between the bracket member 400′ and the cover member 220′ and having a shape corresponding to the bracket member 400′.

In accordance with the present disclosure, as illustrated in FIG. 13, the sealing member 300′ may penetrate the bracket member 400′ and the rubber member 450′ as well as the cover member 220′ in the top-to-bottom direction H.

More specifically, as illustrated in FIGS. 12, 14, and 15, the sealing member 300′ may be spaced apart from the internal space, in which the battery cell unit 100′ is disposed, in the front-to-rear direction F and the side-to-side direction W.

In this case, it may be understood that, when the cover member 220′ has approximately a rectangular plate shape, the sealing member 300′ penetrates a corner region of the cover member 220′.

Hereafter, a battery pack assembly in accordance with a third embodiment of the present disclosure will be described in detail with reference to the accompanying drawings.

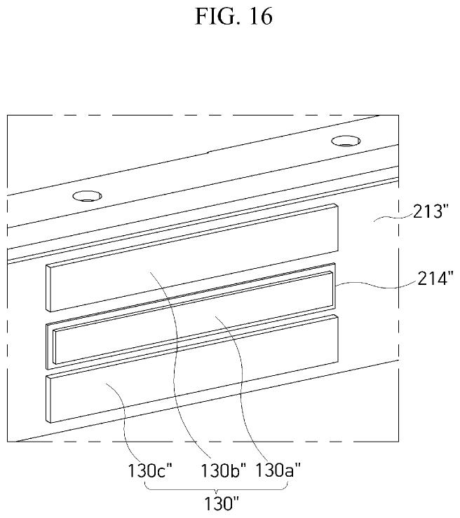

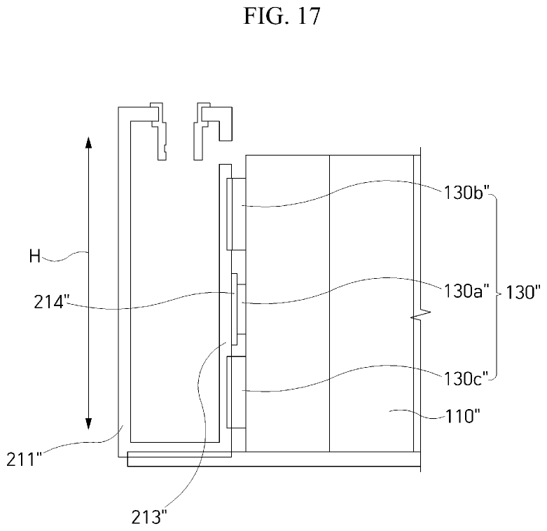

FIG. 16 is a perspective view illustrating the structure of a buffer member included in the battery pack assembly in accordance with the third embodiment of the present disclosure, and FIG. 17 is an expanded vertical cross-sectional view illustrating a cross-sectional structure of an end portion of the battery pack assembly in accordance with the third embodiment of the present disclosure in a front-to-rear direction.

As will be described below, a battery pack assembly 600″ in accordance with the third embodiment of the present disclosure is different from the battery pack assembly 600′ in accordance with the second embodiment of the present disclosure in terms of only a buffer member 130″.

Therefore, the descriptions of components except the buffer member 130″ in the battery pack assembly 600″ in accordance with the third embodiment of the present disclosure may be replaced with those of the components of the battery pack assembly 600′ in accordance with the second embodiment of the present disclosure.

Referring to FIGS. 16 and 17, a front buffer member 131″ or a rear buffer member 132″ may include a plurality of buffer regions spaced apart from each other in the top-to-bottom direction H or the side-to-side direction W.

For example, FIGS. 16 and 17 illustrate that the plurality of buffer regions are spaced apart from each other in the top-to-bottom direction H.

More specifically, the plurality of buffer regions included in the front buffer member 131″ or the rear buffer member 132″ may include a center buffer region 130a″ disposed in the middle in the top-to-bottom direction H, an upper buffer region 130b″ spaced apart upward from the center buffer region 130a″, and a lower buffer region 130c″ spaced apart downward from the center buffer region 130a″.

In accordance with the third embodiment of the present disclosure, a frame member 210″ may further include a reinforcement member 214″ protruding toward the center buffer region 130a″ disposed in a region of a partition 213″, facing the center buffer region 130a″, and configured to pressurize the center buffer region 130a″.

The reinforcement member 214″ may be made of a metallic material.

As described above, while the battery pack assembly 600″ is used, a battery cell 110″ may swell.

The buffer member is a component for preventing the swelling.

In particular, the swelling significantly occurs in a battery cell located in the central region, among the battery cells.

Therefore, in order to effectively suppress the swelling, the battery cells in the central region need to be relatively strongly pressurized.

For this operation, in accordance with the third embodiment of the present disclosure, the reinforcement member 214″ may be disposed in the region facing the center buffer region 130a″.

That is, since the reinforcement member 214″ made of a metallic material protrudes from the partition 213″, the reinforcement member 214″ may more strongly pressurize the center buffer region 130a″, thereby effectively preventing the swelling that occurs in the central region.

As illustrated in FIG. 17, the thickness of the upper buffer region 130b″ and the thickness of the lower buffer region 130c″ may correspond to the sum of the thickness of the center buffer region 130a″ and the thickness of the reinforcement member 214″, and the thickness of the center buffer region 130a″ may be smaller than the thickness of the upper buffer region 130b″ and the thickness of the lower buffer region 130c″.

Hereafter, a battery pack assembly in accordance with another embodiment of the third embodiment of the present disclosure will be described in detail with reference to the accompanying drawings.

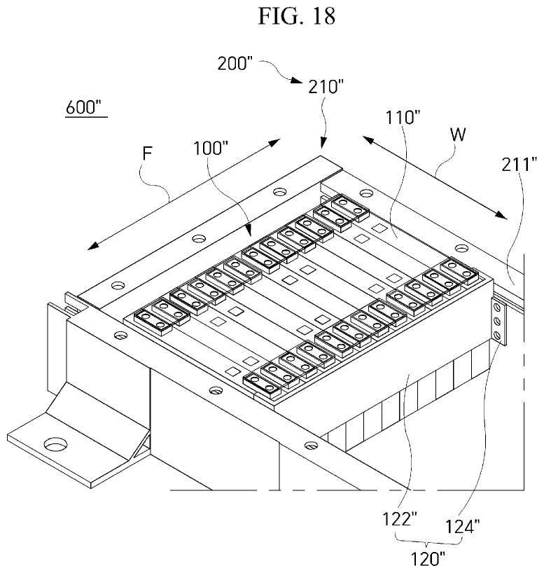

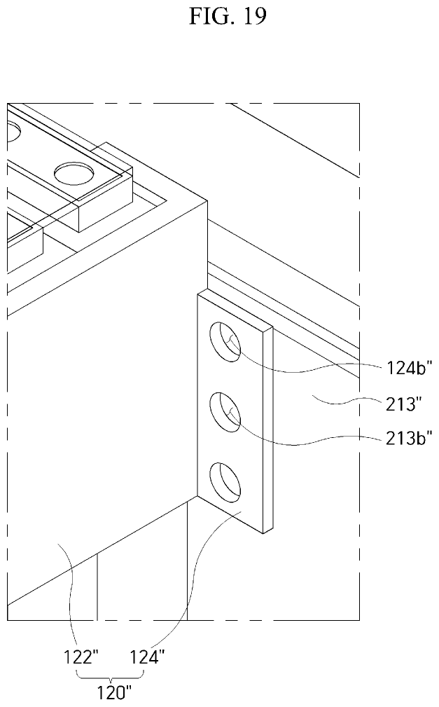

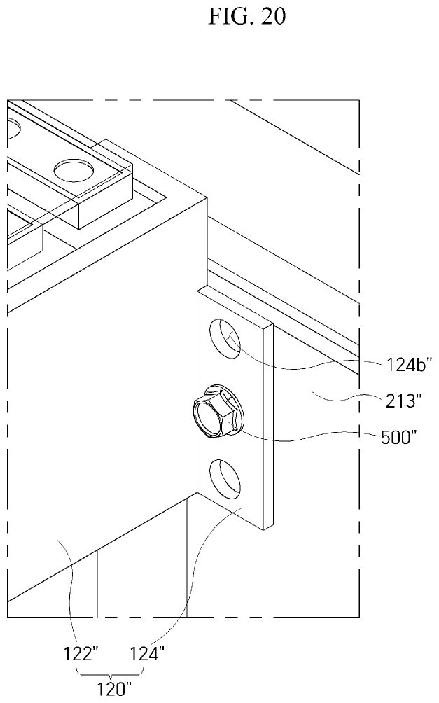

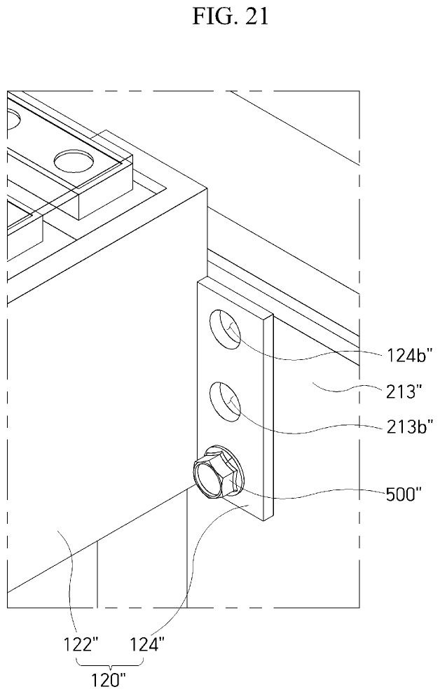

FIG. 18 is a perspective view illustrating that a battery cell unit is mounted on a frame member of a battery pack assembly in accordance with another embodiment of the third embodiment of the present disclosure, FIG. 19 is an expanded perspective view illustrating the battery pack assembly in accordance with the another embodiment of the third embodiment of the present disclosure, before the battery cell unit and the frame member are coupled, FIG. 20 is a perspective view illustrating a coupling structure between the battery cell unit and the frame member when the battery cell unit of the battery pack assembly in accordance with the another embodiment of the third embodiment of the present disclosure has a first height in a top-to-bottom direction, and FIG. 21 is a perspective view illustrating a coupling structure between the battery cell unit and the frame member when the battery cell unit of the battery pack assembly in accordance with the another embodiment of the third embodiment of the present disclosure has a second height in the top-to-bottom direction.

A battery pack assembly 600″ in accordance with the another embodiment of the third embodiment has the same structure as the battery pack assembly 600′ in accordance with the second embodiment of the present disclosure in that the cell fixing member 120″ is directly coupled to the frame member 210″.

However, the battery pack assembly 600″ in accordance with the another embodiment of the third embodiment is different from the battery pack assembly 600′ in accordance with the second embodiment of the present disclosure in terms of a first through-hole 213b″, a second through-hole 124b″, and a bolt member 500″ which will be described below.

Therefore, the descriptions of components except the first through-hole, the second through-hole, and the bolt member in the battery pack assembly 600″ in accordance with the another embodiment of the third embodiment of the present disclosure may be replaced with those of the components of the battery pack assembly 600′ in accordance with the second embodiment of the present disclosure.

More specifically, the battery pack assembly 600″ in accordance with the another embodiment of the third embodiment of the present disclosure may include a battery cell unit 100″ and a case 200″ for housing the battery cell unit 100″. The battery cell unit 100″ may include a plurality of battery cells 110″ disposed in parallel to the front-to-rear direction F, a cell fixing member 120″ provided on either side of the plurality of battery cells 110″ in the side-to-side direction W and configured to pressurize the plurality of battery cells 110″ in the side-to-side direction W, and a buffer member 130″ provided on each of front and rear surfaces of the battery cell unit 100, configured to pressurize the plurality of battery cells 110″ in the front-to-rear direction F, and made of an elastic material.

The buffer member 130″ may be configured to absorb a change in volume of the battery cell 100″ when the battery cell 100″ swells.

In this case, the case 200″ may include a frame member 210″ having an internal space in which the battery cell unit 100″ is housed, and the frame member 210″ may include a frame member body 211″ configured to form the body of the frame member 210″ and having the internal space formed therein, and a partition 213″ disposed in the internal space of the frame member body 211″, spaced apart from the edge surface of the frame member body 211″ toward the battery cell 110″, and configured to partition the internal space into a plurality of spaces.

In accordance with the another embodiment of the third embodiment, the partition 213″ may have the first through-hole 213b″ formed therein, and the cell fixing member 120″ may include a body region 122″ brought into close contact with the plurality of battery cells 110″ and extended in the front-to-rear direction F and an assembly region 124″ protruding from an end portion of the body region 122″ in the front-to-rear direction F to the outside in the side-to-side direction.

In accordance with the another embodiment of the third embodiment, the assembly region 124″ may have the second through-hole 124b″ facing the first through-hole 213b″, and the battery pack assembly 600″ may include the bolt member 500″ configured to pass through the first and second through-holes 213b″ and 124b″.

In accordance with the another embodiment of the third embodiment, the bolt member 500″ may be a component for fixing and coupling the cell fixing member 120″ to the frame member 210.

In accordance with the another embodiment of the third embodiment, the second through-hole 124b″ may be provided as a plurality of second through-holes arranged in the top-to-bottom direction of the assembly region 124″.

The sizes of the plurality of second through-holes 124b″ formed in the assembly region 124″ may be equal to each other or correspond to each other.

In accordance with the another embodiment of the third embodiment, the first through-hole 213b″ may selectively face any one of the plurality of second through-holes 124b″, and the bolt member 500″ may be passed through both the first through-hole 213b″ and the second through-hole 124b″ facing the first through-hole 213b″.

Therefore, in accordance with the another embodiment of the third embodiment, the second through-hole 124b″ through which the bolt member 500 is passed may be properly selected according to the top-to-bottom height of the battery cell 110″ included in the battery cell unit 100″.

Therefore, it is possible to fabricate the battery pack assemblies 600″ having different top-to-bottom heights based on various standards by using the cell fixing member 120″ based on one standard.

While various embodiments have been described above, it will be understood to those skilled in the art that the embodiments described are by way of example only. Accordingly, the disclosure described herein should not be limited based on the described embodiments.

What is claimed is:

1. A battery pack assembly comprising:
a plurality of battery cell units, each battery cell unit comprising a plurality of battery cells and a support bar configured to fix the plurality of battery cells;
a case having a frame shape, and configured to house the battery cell units therein; and
a plurality of surface pressure pads disposed in the case, each surface pressure pad being disposed between the case and an outermost battery cell on both ends of each of the plurality of battery cell units.

2. The battery pack assembly of claim 1, wherein the battery cell units are disposed along a longitudinal direction of the case.

3. The battery pack assembly of claim 1, wherein the case comprises:
a frame member that defines a body of the case;
a cover member disposed on the frame member and configured to cover the frame member; and
a gasket disposed between the frame member and the cover member.

4. The battery pack assembly of claim 3, wherein the frame member comprises:
a pair of first frames spaced apart from each other, and disposed adjacent to the outermost battery cells on both ends of each of the plurality of battery cell units, respectively; and
a pair of second frames spaced apart from each other, and respectively disposed ends of the first frame.

5. The battery pack assembly of claim 4, wherein each of the first frames comprises:
a cut area disposed at a position corresponding to one of the surface pressure pads; and
an elastic part elastically deformed by the cut area and abutting the respective surface pressure pad.

6. The battery pack assembly of claim 5, wherein each elastic part has a smaller area than each of the battery cells, and has a larger area than each of the surface pressure pads.

7. The battery pack assembly of claim 5, wherein each of the first frames has a cross-section corresponding to a rectangular frame shape, and
the cut area and the elastic part of each of the first frames are disposed at facing surfaces of the pair of first frames.

8. The battery pack assembly of claim 3, wherein the gasket is coupled to the frame member and the cover member through bolting.

9. The battery pack assembly of claim 4, wherein the gasket comprises:
a support member formed in a rectangular frame shape, and having a bottom surface that comes into surface contact with a top surface of the frame member;
a pair of pressurization members disposed at positions corresponding to the pair of first frames; and
a pair of cover fixing members disposed at position corresponding to the pair of second frames,
wherein the cover member is seated on the top surface of the support member, and the pressurization member and the cover fixing member are seated on the top surface of the cover member.

10. A battery pack assembly comprising:
a battery cell unit; and
a case configured to house the battery cell unit,
wherein the battery cell unit comprises a plurality of battery cells arranged in parallel to a front-to-rear direction,
wherein the case comprises a frame member defining an internal space in which the battery cell unit is housed,
wherein the frame member comprises:
a frame member body defining a body of the frame member, and having the internal space disposed therein; and
a partition disposed in the internal space, spaced apart from an edge surface of the frame member body toward the battery cell, and configured to partition the internal space into a plurality of spaces,
wherein the partition comprises a through-area through which the spaces partitioned by the partition communicate with each other.

11. The battery pack assembly of claim 10, wherein the through-area comprises:
a first through-area extended upward; and
a second through-area extended horizontally from the first through-area.

12. The battery pack assembly of claim 10, wherein the battery cell unit comprises:
a cell fixing member disposed on either side of the plurality of battery cells in a side-to-side direction, and configured to pressurize the plurality of battery cells in the side-to-side direction; and
a buffer member disposed on each of a front surface and a rear surface of the battery cell unit, configured to pressurize the plurality of battery cells in the front-to-rear direction, and comprised of an elastic material.

13. A battery pack assembly comprising:
a battery cell unit; and
a case configured to house the battery cell unit,
wherein the battery cell unit comprises:
a plurality of battery cells disposed in parallel to a front-to-rear direction;
a cell fixing member disposed on either side of the plurality of battery cells in a side-to-side direction, and configured to pressurize the plurality of battery cells in the side-to-side direction; and
a buffer member disposed on each of a front surface and a rear surface of the battery cell unit, configured to pressurize the plurality of battery cells in the front-to-rear direction, and comprised of an elastic material,
wherein the case comprises:
a frame member defining an internal space in which the battery cell unit is housed; and
a cover member coupled to a top of the frame member,
wherein the cell fixing member is coupled to the frame member, and
the buffer member is spaced apart from the cell fixing member.

14. The battery pack assembly of claim 13, wherein the frame member comprises:
a frame member body defining a body of the frame member, and having the internal space disposed therein; and
a protrusion member protruding from the frame member toward the internal space,
wherein the cell fixing member comprises:
a body region in close contact with the plurality of member cells, and extended in the front-to-rear direction; and
an assembly region having an indented portion protruding from an end portion of the body region in the front-to-rear direction to the outside in a side-to-side direction, and indented upward,
wherein the protrusion member is inserted into and coupled to the indented portion of the assembly region.

15. The battery pack assembly of claim 14, wherein a width of the protrusion member in the side-to-side direction corresponds to a width of the indented portion in the side-to-side direction.
